(19) United States
(12) Patent Application Publication
(10) Pub. No.: US 2025/0196366 A1
(43) Pub. Date: Jun. 19, 2025

(54) FIXTURE AND METHOD FOR TRANSFERRING BUNDLED CARDBOARD

(71) Applicant: ABB SCHWEIZ AG, Baden (CH)

(72) Inventors: Yuhao ZHAO, Shanghai (CN); Yifan CHEN, Shanghai (CN); Wenyong ZHOU, Shanghai (CN); Yin TIAN, Shanghai (CN)

(21) Appl. No.: 19/042,362

(22) Filed: Jan. 31, 2025

Related U.S. Application Data
(63) Continuation of application No. PCT/CN2022/115469, filed on Aug. 29, 2022.

(51) Int. Cl. B25J 15/00; B25J 9/14; B25J 15/02; B25J 15/06

(52) U.S. Cl. CPC B25J 15/0014; B25J 9/14; B25J 15/0019; B25J 15/0253; B25J 15/0616

(57) ABSTRACT

A fixture and a method for transferring a bundled cardboard. The fixture for transferring a bundled cardboard includes a frame extending substantially in a first direction and having an upper side and a lower side. The fixture also has a first gripper attached to the frame at a first place adjacent to the upper side and having a gripping plate extending in a second direction perpendicular to the first direction. The gripping plate includes a gripping surface adapted to engage with a first surface of the bundled cardboard. The fixture also includes a second gripper attached to the frame at a second place adjacent to the lower side and having at least one clamping arm.

### FIELD

Embodiments of the present disclosure generally relate to a field of industrial robots, and more particularly to a fixture and a method for transferring a bundled cardboard.

### BACKGROUND

In packing industries, cardboard boxes are widely used for containing products. The packaged products thus can be delivered. With the increasing demand for cardboards, carton manufacturers will firstly bind multiple pieces of cardboards and the bundled cardboards then are transported to industrial factories. During this process, the bundled cardboards need to be transferred or moved from one position to another, for example, loaded, unloaded, or moved to a specific position where the cardboards are further processed (for example, unfolded), and the like.

Conventionally, processes of the bundled cardboards, such as, loading, unloading, cutting and the like, are manually performed, which is not only time- consuming but labor-consuming. These processes are of lower efficiency and high costs and also are subject to safety risks since operators have to be in a work area. There is an increasing need to automate handling of the bundled cardboards.

### SUMMARY

Example embodiments of the present disclosure provide a fixture and a

method for transferring a bundled cardboard which can improve automation degree of handling of a bundled cardboard.

In a first aspect of the present disclosure, it is provided a fixture for transferring a bundled cardboard. The fixture comprises a frame extending substantially in a first direction and comprising a upper side and a lower side; a first gripper attached to the frame at a first place adjacent to the upper side and comprising a gripping plate extending in a second direction perpendicular to the first direction, the gripping plate comprising a gripping surface adapted to engage with a first surface of the bundled cardboard; and a second gripper attached to the frame at a second place adjacent to the lower side and comprising at least one clamping arm, the clamping arm adapted to abut against a second surface of the bundled cardboard, the second surface being opposite to the first surface. With this arrangement, the bundled cardboard can be automatically handled.

In some embodiments, the first gripper may be movably attached to the frame such that the gripping plate is linearly movable along the first direction to change a distance between the gripping surface and the clamping arm. With this arrangement, the gripping force for gripping the bundled cardboard can be adjusted.

In some embodiments, the fixture may further comprise a first pneumatic actuator fixedly attached to the frame and configured to move the first gripper along the first direction. With this arrangement, the first gripper can be moved by a pneumatic actuator. Weight of the fixture can thus be reduced.

In some embodiments, the gripping surface may be configured to engage with the first surface of the bundled cardboard via a vacuum suction. With this arrangement, the bundled cardboard can be easily picked up.

In some embodiments, the gripping plate may comprise M suction points distributed on the gripping surface and grouped into N groups, the suction points in each group being controlled by one air circulation circuit, M being an integer greater than 3, N being an integer between 1 and M. With this arrangement, the bundled cardboard can be reliably held by a plural of suction points.

In some embodiments, the second gripper may be rotationally attached to the frame such that the clamping arm is rotatable around the first direction between an extended position at which the clamping arm protrudes from the frame and a retracted position at which the clamping arm does not enter a projection area of the gripping surface along the first direction. With this arrangement, the second gripper does not interface with the picking up operation of the bundled cardboard.

In some embodiments, the second gripper may comprise at least two clamping arms spaced from each other to abut against the second surface of the bundled cardboard at different positions, the at least two clamping arms being synchronously moved. With this arrangement, the bundled cardboard can be firmly and reliably held.

In some embodiments, the fixture may further comprise a second pneumatic actuator fixedly attached to the frame and a linkage mechanism configured to receive an output force from the second pneumatic actuator to synchronously drive the at least two clamping arms. With this arrangement, the second gripper can be driven by a pneumatic actuator. Weight of the fixture can thus be reduced.

In some embodiments, the frame may comprise an upper mount portion adapted to be attached to a robotic arm and a lower support portion adapted to abut against a side surface of the bundled cardboard.

In some embodiments, the fixture may further comprise a cutting device comprising a body fixedly attached to the frame; a fixed cutter fixedly attached to the body; and a movable cutter rotationally attached to the body, the movable cutter being rotatable between a cutting position at which the movable cutter contacts the fixed cutter to cut off a belt of the bundled cardboard and a separation position at which the movable cutter is separate from the fixed cutter. With this arrangement, the tie belt for binding the bundled cardboard can be cut off with the cutting device.

In some embodiments, the cutting device may comprise a third pneumatic actuator configured to drive the movable cutter, the movable cutter being shaped to rotate in response to a linear movement of the pneumatic actuator.

In some embodiments, the fixture may further comprise a belt supporting device configured to hold the belt that has been cut off from the bundled cardboard, comprising a groove arranged in the body; and a clamping member fixed to the movable cutter, extending in parallel with the movable cutter and configured to engage with the groove when the movable cutter is at the cutting position. With this arrangement, the belt that has been cut off from the bundled cardboard can be collected.

In a second aspect of the present disclosure, it is provided a method for transferring a bundled cardboard. The method comprises: picking up the bundled cardboard by acting on a first surface of the bundled cardboard by a first gripper; rotating a second gripper to abut against a second surface of the bundled cardboard, the second surface being opposite to the second surface; moving the first gripper toward the second gripper to reduce a distance between the first and second grippers; and transferring the bundled cardboard.

In some embodiments, the picking up may comprise vacuum sucking the first surface of the bundled cardboard by the first gripper.

In a third aspect of the present disclosure, it is provided a robot comprising a robotic arm; and a fixture for transferring a bundled cardboard according to any of the first aspect, the fixture being attached to the robotic arm.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view of a robot for transferring a bundled cardboard according to one example embodiment of the present disclosure;

FIG. 2 is a schematic view of a fixture for transferring a bundled cardboard according to one example embodiment of the present disclosure;

FIG. 3 is a schematic view of a fixture for transferring a bundled cardboard according to one example embodiment of the present disclosure from a different perspective;

FIG. 4 is a bottom view of a first gripper of the fixture for transferring a bundled cardboard according to one example embodiment of the present disclosure;

FIG. 5 is a side view of a cutting device of the fixture for transferring a bundled cardboard according to one example embodiment of the present disclosure;

FIG. 6 is a perspective view of the cutting device of the fixture for transferring a bundled cardboard according to one example embodiment of the present disclosure;

FIG. 7 is a flow chart of the method for transferring a bundled cardboard according to one example embodiment of the present disclosure;

FIG. 8 is a schematic view of the robot for transferring a bundled cardboard of FIG. 1 as viewed from a different perspective;

FIG. 9 is a schematic view of a robot for transferring a bundled cardboard according to one example embodiment of the present disclosure, showing a state that the bundled cardboard being clamped by the first and second grippers with the second gripper at an extended position;

FIG. 10 is a schematic view of the robot for transferring a bundled cardboard of FIG. 8 as viewed from a different perspective;

FIG. 11 is a schematic view of a robot for transferring a bundled cardboard according to one example embodiment of the present disclosure, showing a state that the bundled cardboard being placed into a U-shaped storage groove;

FIG. 12 is a schematic view of a robot for transferring a bundled cardboard according to one example embodiment of the present disclosure, showing a state that a belt of the bundled cardboard being cut by the cutting device of the fixture; and

FIG. 13 is a plane view of the robot for transferring a bundled cardboard of FIG. 11.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

In order to facilitate storage and transportation, a plural of cardboards are bundled together with one or more tie belts to form a bundled cardboard. At industrial fields, these bundled cardboards needs loaded and/or unloaded frequently. For example, the bundled cardboards are transported to a workstation where the bundled cardboards are processed. In many applications, belts on the bundled cardboards need to be cut off so as to release the bundled cardboard. The released bundled cardboards can be further processed, for example, unfolded into a container.

Conventionally, these handling processes are performed manually, which is labor intensive and time-consuming, and may be subject to safety risks. According to the present disclosure, a fixture for transferring a bundled cardboard are proposed, which is adapted to perform at least one of the following: picking up the bundled cardboard, holding and moving the bundled cardboard, and adjusting a posture of the bundled cardboard, and the like.

Through the following detailed descriptions with reference to the accompanying drawings, the above features and advantages of the example embodiments disclosed herein will become more comprehensible.

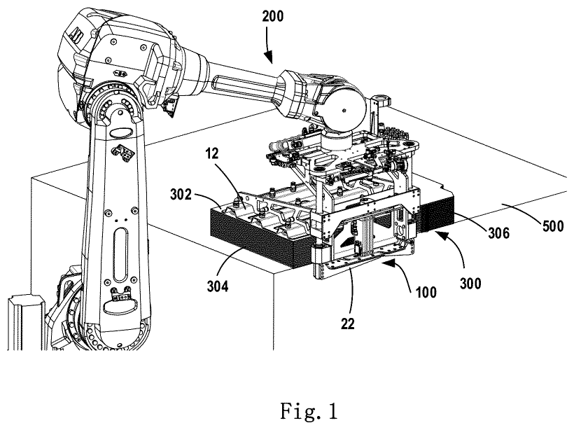

FIG. 1 is a schematic view of a robot for transferring a bundled cardboard according to one example embodiment of the present disclosure. As shown in FIG. 1, the robot may comprise a fixture 100 for transferring a bundled cardboard 300 and a robotic arm 200. The fixture 100 is attached to the robotic arm 200. By controlling the robotic arm 200, the fixture 100 can move freely in a working space so as to handle the bundled cardboard 300 properly.

As shown in FIG. 1, the bundled cardboard 300 is formed by a plural of cardboards which are stacked in one direction and comprises a first surface 302, a second surface 304 opposite to the first surface 302 and a side surface 306. The first surface 302 and the second surface 304 are substantially flat (corresponding to the horizontal plane in the shown figure). The side surface 306 is along the stacking direction of the folded cardboards and is formed by the sides of the folded cardboards.

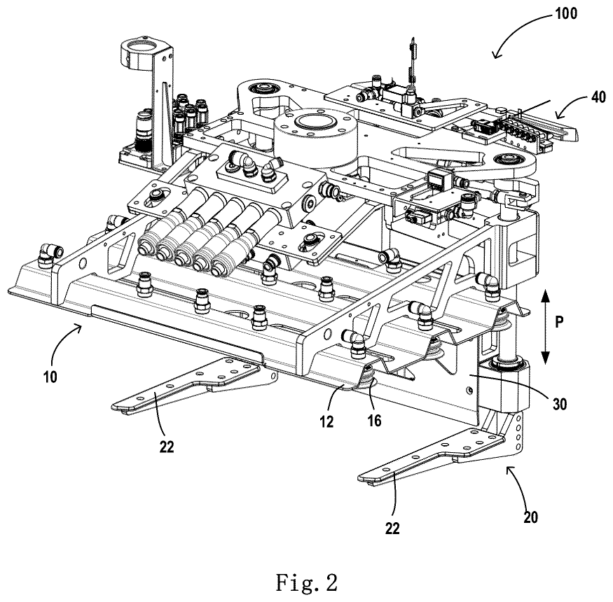

FIGS. 2-4 show schematic views of a fixture 100 for transferring a bundled cardboard according to one example embodiment of the present disclosure.

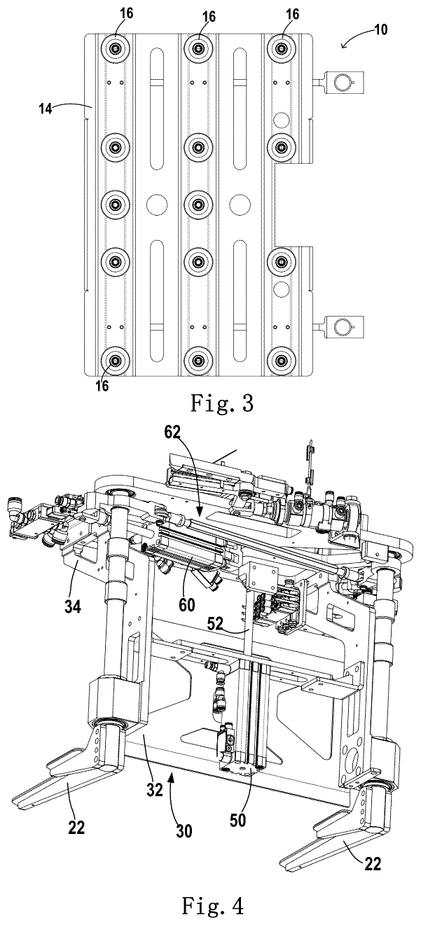

As shown in FIGS. 2 and 3, the fixture 100 for transferring a bundled cardboard comprises a frame 30, a first gripper 10, and a second gripper 20. The frame 30 extends substantially in a first direction denoted by a reference sign “P” and comprises an upper side and a lower side. In some embodiments, as shown in FIG. 2, the frame 30 is formed as a substantially a flat plate extending in the first direction P. Some portions of the plate are removed so as to reduce the weight of the frame. Components of the fixture may be arranged on the frame 30.

In some embodiments, as shown in FIGS. 2 and 3, the frame 30 comprises an upper mount portion 34 and a lower support portion 32. The upper mount portion 34 may extend from the lower support portion 32 obliquely. In this way, complementary components for operating the fixture, for example, air circulation components, actuators, coupling means, and the like, can be properly arranged on the fixture. The fixture 100 can be attached to the robotic arm 200 at the upper mount portion 34. The lower support portion 32 may be of a plate form and can abut against a side surface 306 of the bundled cardboard 300. In this way, the bundled cardboard 300 can also be partially supported by the frame.

The first direction P is corresponding to a stacking direction of the cardboards. The frame 30 may include a coupling means 33 for attaching the fixture 100 to the robotic arm 200. In the shown example, the coupling means 33 includes a flange which is configured to couple to the corresponding coupling means of the robotic arm 200. It is to be understood that this is merely illustrative rather than limited and the coupling means may be formed as any other proper forms, such as holes, as long as the coupling means can attach the frame 30 to the robotic arm.

The first gripper 10 is attached to the frame 30 at a first place adjacent to the upper side. The first gripper 10 is configured to draw a first surface of the bundled cardboard 300 from one side (in the shown example, a top side). In some embodiments, as shown in FIGS. 2 and 3, the first gripper 10 comprises a gripping plate 12 extending in a second direction (in the shown example, the section direction is parallel with the first surface 302 of the bundled cardboard) perpendicular to the first direction P. The gripping plate 12 comprises a gripping surface 14 which is adapted to engage with the first surface 302 of the bundled cardboard 300. With this arrangement, the fixture 100 can pick up the bundled cardboard 300 from a single one side of the bundled cardboard 300. In view of the fact that when a plural of the bundled cardboards 300 are stacked on a platform 500, a bottom side of the bundled cardboard 300 cannot be accessed. When the bundled cardboard 300 can be picked up from merely one side, this is advantageous.

In some embodiments, as shown in FIGS. 2 and 3, the second gripper 20 is attached to the frame 30 at a second place adjacent to the lower side. The second gripper 20 is configured to clamp the bundled cardboard 300 from a second side (in the shown example, a bottom side). The second gripper 20 may comprise at least one clamping arm 22. In the shown examples, there are two clamping arms 22. It is to be understood that this is merely rather than limited and the number of clamping arms 22 may be 1, 3, 4 or more. The clamping arm 22 is configured to abut against a second surface 304 of the bundled cardboard 300. By provision of the second gripper 20, the clamping arm 22 may clamp the bundled cardboard 300 from its bottom side. By cooperation of the first gripper and the second gripper, the bundled cardboard 300 can be firmly held between the first gripper 10 and the second gripper 20.

In some embodiments, as shown in FIGS. 2 and 3, the first gripper 10 is movably attached to the frame 30. For example, the gripping plate 12 is linearly movable along the first direction P. In this way, a distance between the gripping surface 14 and the clamping arm 22 can be adjusted. By adjusting the distance between the gripping surface 14 and the clamping arm 22, the gripping strength of the fixture with respect to the bundled cardboard 300 can be easily adjusted. When the gripping surface 14 is closer to the clamping arm 22, the bundled cardboard 300 can be firmly held by the fixture.

The fixture 100 may comprise various drive means for moving the first gripper 10. In some embodiments, the drive means includes a pneumatic actuator. As shown in FIG. 3, the pneumatic actuator 50 is fixedly attached to the frame 30 and comprises a cylinder and a drive rod 52 arranged in the cylinder. The drive rod 52 configured to extend and retract by control gas flow in the air circulation circuit. It is to be understood that this is merely rather than limited, the drive means may take any other proper forms, for example, electric servo actuator.

The fixture 100 may have various implementations for engaging with a first surface 302 of the bundled cardboard 300 so as to pick up the bundled cardboard 300.

In some embodiments, as shown in FIG. 4, the gripping surface 14 is configured to engage with the first surface 302 of the bundled cardboard 300 via a vacuum suction. For example, the gripping plate 12 comprises a plural of suction points 16 distributed on the gripping surface 14. The number M of the suction points 16 may be chosen according to the size of the bundled cardboard 300. In some embodiments, the suction points 16 can be arranged in a matrix form so as to a drawing force for attracting the bundled cardboard 300 can be evenly distributed. In the shown example, there are fourteen suction points 16 arranged in 5 rows. It is to be understood that this is merely rather than limited, the number of suction points 16 may be any other number and any other proper arrangement as long as the suction force formed by the suction points 16 can reliably pick up the bundled cardboard 300.

In some embodiments, the suction points 16 are grouped into N groups, N being smaller than M. In this way, valve arrangements for air circulation can be simplified. In some embodiments, the suction points in each group may be controlled by one air circulation circuit. With this arraignment, even if one suction point 16 in one group is blocked, the other groups are not influenced. It is to be understood that vacuum suction is merely one exemplary way for engaging with the bundled cardboard 300, the way for engaging with the bundled cardboard 300 may take any other proper forms, for example, by magnetic force.

In some embodiments, as shown in FIG. 3, the second gripper 20 is rotationally attached to the frame 30. In this way, the clamping arm 22 is rotatable around the first direction P between an extended position and a retracted position. When the clamping arm 22 is at the extended position, the clamping arm 22 protrudes from the frame 30 and thus can abut against the bottom surface of the bundled cardboard 300. When the clamping arm 22 is at the retracted position, the clamping arm 22 does not enter a projection area of the gripping surface 14 along the first direction and thus does not interference with the bundled cardboard 300. With this rotation arrangement, the second gripper 20 can be selectively operated so as to handle the bundled cardboard 300 in a proper way.

In some embodiments, as shown in FIGS. 2 and 3, the second gripper 20 comprises two clamping arms 22 spaced from each other. In this way, the two clamping arms 22 can abut against the second surface 304 of the bundled cardboard 300 at different positions. In this way, the bundled cardboard 300 can be further firmly held by the gripper. The two clamping arms 22 are synchronously driven. In some embodiments, the fixture 100 may comprise a second pneumatic actuator 60. The second pneumatic actuator 60 is fixedly attached to the frame 30. The fixture 100 may further comprise a linkage mechanism 62 configured to receive an output force from the second pneumatic actuator 60 to synchronously drive the two clamping arms 22. It is to be understood that the linkage mechanism 62 may take any proper forms as long as the linear movement of the second pneumatic actuator 60 can be transformed to the rotational movements of the two clamping arms 22. Alternatively, the second pneumatic actuator 60 may be replaced by any other proper actuator, for example, electrical actuator.

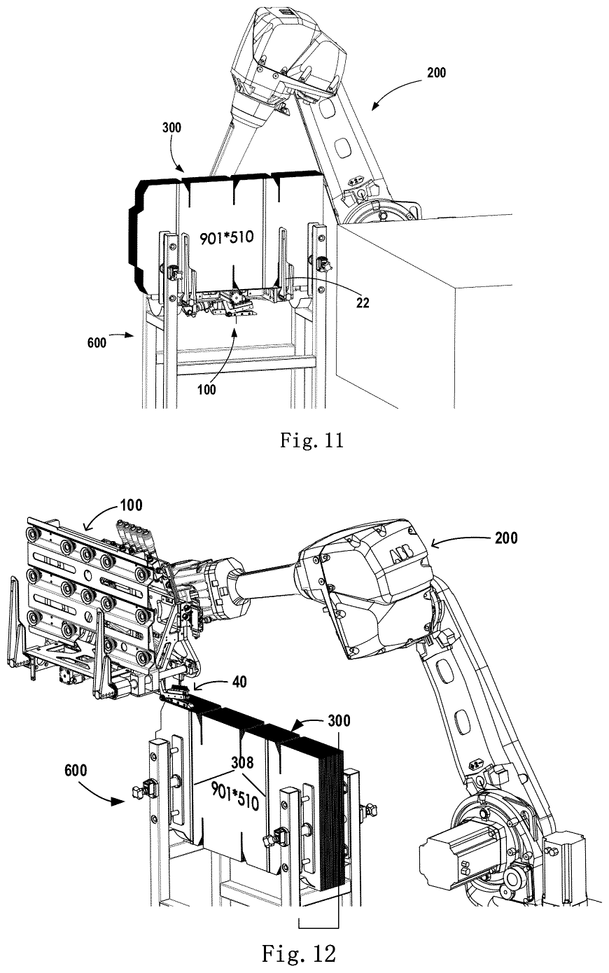

In some embodiments, the fixture 100 may further comprise a cutting device 40. With the cutting device 40, the belt 308 (referring to FIGS. 11 and 12) for binding the bundled cardboard 300 can be cut off automatically. The cutting device may take various forms.

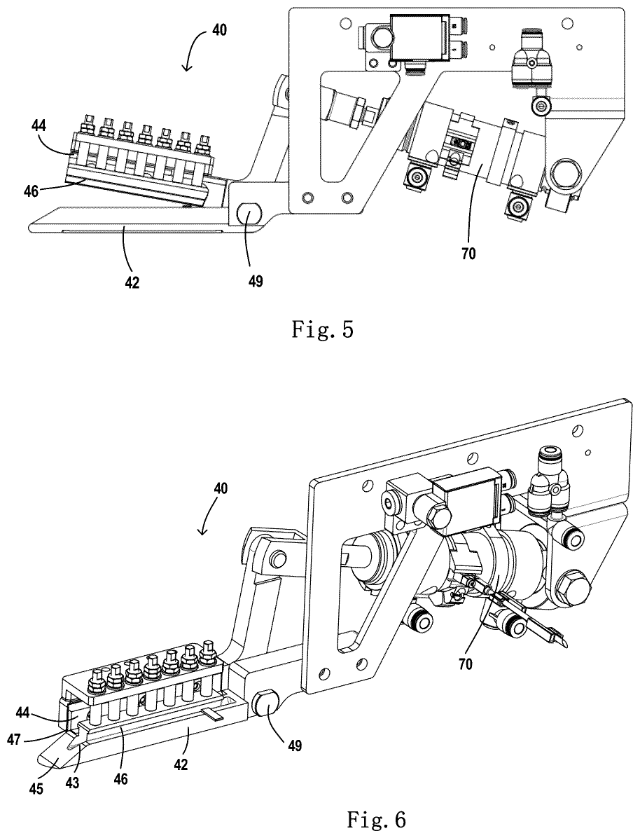

FIGS. 5 and 6 show one example of the cutting device 40. As shown in FIGS. 5 and 6, the cutting device 40 may comprises a body 42. The body may be fixedly attached to the frame 30, for example, at a side opposite to a side for holding the bundled cardboard 300. The cutting device 40 may further comprise a fixed cutter 47 and a movable cutter 44. The fixed cutter 47 (not shown) may be fixedly attached to the body 42, for example as shown in FIG. 5, at a side of the body. The movable cutter 44 may be pivotally attached to the body 42 for example, via a pivotal shaft 49. In the shown example, the movable cutter 44 is arranged on one side of a support. With this arrangement of the movable cutter 44 and the fixed cutter 47, the cutting blades would not be exposed to the outside and the safety can be improved.

The movable cutter 74 is rotatable between a cutting position at which the movable cutter contacts the fixed cutter to cut off a belt of the bundled cardboard 300 and a separation position at which the movable cutter is separate from the fixed cutter. To operate the cutting device, the movable cutter 44 may be rotated around the pivotal shaft 49 and engagement of the movable cutter 44 and the fixed cutter 47 cuts off the belt therebetween. rotationally attached to the body,

In some embodiments, as shown in FIGS. 5 and 6, the cutting device 40 may comprise a pneumatic actuator 70 configured to drive the movable cutter. The movable cutter 74 is configured to rotate in response to a linear movement of the pneumatic actuator. It is to be understood that this is merely rather than limited, the drive means for driving the movable cutter 74 may take any other proper forms, for example, electric servo actuator.

In some embodiments, as shown in FIGS. 5 and 6, the body 42 may comprise a tapered frontal end. With the tapered shape of the frontal end, the belt can be easily guided into the cutting device 40.

In some embodiments, as shown in FIGS. 5 and 6, the cutting device 40 may comprise a belt supporting device configured to hold the belt that has been cut off from the bundled cardboard 300. With the belt supporting device, the belt cut off can be held by the fixture 100 and then can be placed at a proper position. In this way, the belt cut off would not be released at random which otherwise would mess up the environment of the workstation.

In some embodiments, as shown in FIGS. 5 and 6, the belt supporting device may comprise a groove arranged in the body with and a clamping member 46 fixed to the movable cutter 44. The movable cutter 44 extends in parallel with the movable cutter and move together with the movable cutter 44. When the movable cutter 44 rotates, the clamping member 46 also rotates and engages with the groove when the movable cutter is at the cutting position. When the belt between the movable cutter 44 and the fixed cutter 47 are cut off, the remaining belt would not slip off but maintained within the groove by the clamping member 46. In some embodiments, the clamping member 46 may be made of rubber and is arranged on an exposed side of the movable cutter. In this way, the safety of the cutting device can be further improved.

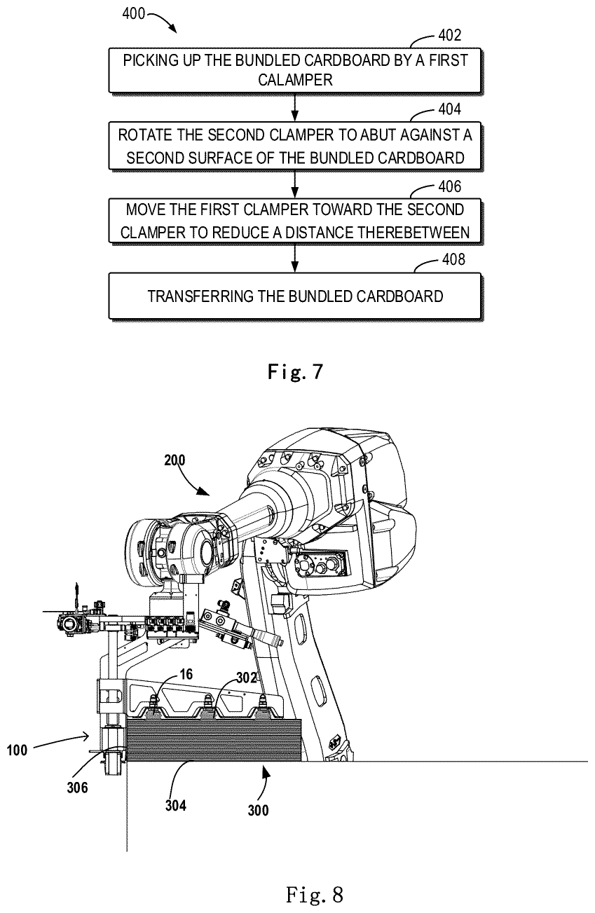

FIG. 7 is a flow chart of the method 400 for transferring a bundled cardboard according to one example embodiment of the present disclosure. As shown in FIG. 7, at block 402, the bundled cardboard 300 is picked up by acting on the first surface 302 of the bundled cardboard 300 by a first gripper 10. In some embodiments, the picking up comprising vacuum sucking the first surface 302 of the bundled cardboard 300 by the first gripper 10. At block 404, a second gripper 20 is rotated to abut against the second surface 304 of the bundled cardboard 300. In this way, the bundled cardboard 300 can be clamped from two sides. At block 406, the first gripper 10 is moved toward the second gripper 20 to reduce a distance between the first and second grippers. In this way, the bundled cardboard 300 can be firmly held by the fixture. At this state, a posture of the bundled cardboard 300 can be adjusted freely without worries of the dropping risk of the bundled cardboard 300. At block 408, the bundled cardboard 300 can be transferred at anywhere, for example, within a reach of the robotic arm.

With the above method, the bundled cardboard 300 can be picked up and clamped firmly. Since the bundled cardboard 300 is firmly clamped, the posture of the bundled cardboard 300 can be adjusted as desired. The bundled cardboard 300 can thus be moved to any proper position without worries of the dropping risk. It is to be understood that the fixture 100 for transferring a bundled cardboard according to one example embodiment of the present disclosure have a plural of operation methods. The above method is merely illustrative rather than limited.

FIGS. 1 and 8-11 are schematic views of the robot for transferring a bundled cardboard, showing one application scenario of the fixture of the invention. FIGS. 1 and 8-11 show different transferring states of the bundled cardboard 300.

As shown in FIGS. 1 and 8, the bundled cardboard 300 is initially placed on a platform 500. There may be a plural of bundled cardboards 300 on the platform 500. For illustration purpose, only one bundled cardboard 300 is shown. The fixture 100 is carried by the robotic arm 200 and can be moved within a working space of the robotic arm 200. The fixture 100 is firstly moved above the bundled cardboard 300. The first gripper may operate to attract the first surface 302 (i.e., a top surface) of the bundled cardboard 300, for example, via vacuum suction using suction points 16. At this state, the second gripper 20 is at a retracted position. In this way, the bundled cardboard 300 can be easily picked up by the first gripper from a top side. Since the first gripper picks up the bundled cardboard 300 from one side, the operation of the fixture are not influenced by the height of the bundled cardboard 300.

Due to the fact that the bundled cardboard 300 is held only from one side, the posture of the bundled cardboard 300 may not be adjusted. The reason is below. Each bundled cardboard 300 generally comprise a plural of cardboards and are tied up by a belt. When the bundled cardboard 300 are vertically arranged, there is a possibility that the cardboard may slip off from the bundled cardboard 300, which should be avoided.

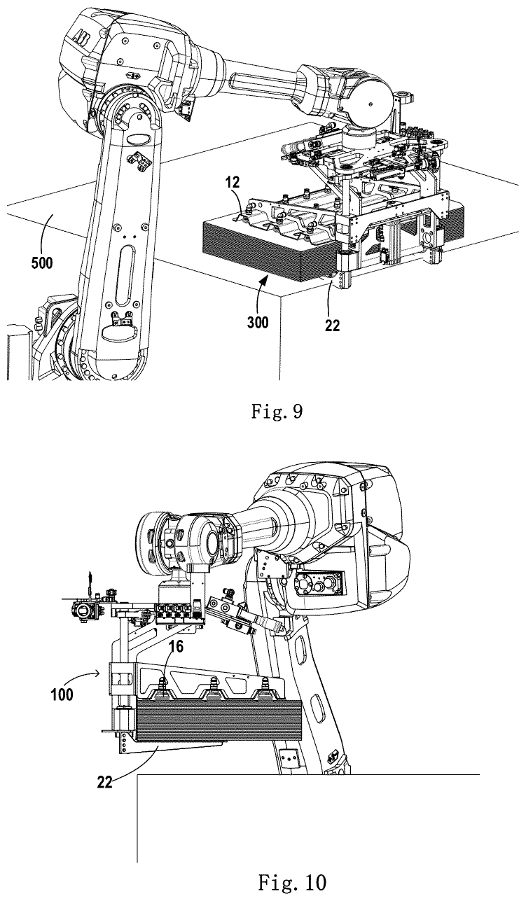

After the bundled cardboard 300 is picked up by the first gripper, the second gripper 20 may operate to abut against the bundled cardboard 300 from a bottom side. As shown in FIGS. 9 and 10, the clamping arm 22 may extend from the frame and be moved to the extended position. In this way, the bundled cardboard 300 can be held from two sides. When the bundled cardboard 300 are held from two sides by the fixture 100, a distance (vertical distance in the shown figures) between the first gripper and the second gripper can be reduced so as to increase the gripping force for clamping the bundled cardboard 300. This may be realized by moving the first gripper toward the second gripper. Alternatively, this may be realized by moving the second gripper toward the second gripper. In this way, the bundled cardboard 300 can be firmly held by the fixture without worries of falling off of the cardboard in the bundled cardboard 300.

As shown in FIG. 11, when the bundled cardboard 300 can be simultaneously held by the first and second grippers, the bundled cardboard 300 can be vertically placed for example, in a U-shaped storage groove 600, for further processing. For example, at the U-shaped storage groove 600, the belt for binding the bundled cardboard 300 can be cut off and then redistributed.

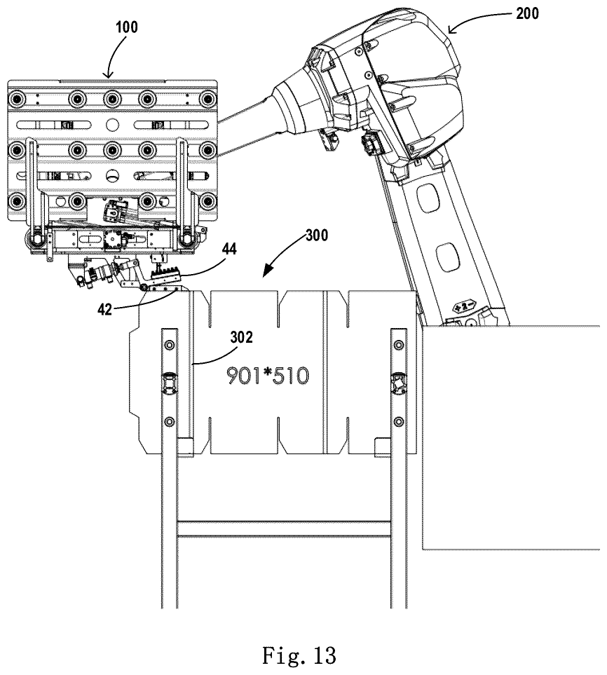

FIGS. 12 and 13 show operation principles of the cutting device 40 of the fixture 100 for transferring a bundled cardboard according to one example embodiment of the present disclosure.

As shown in FIGS. 12 and 13, when the bundled cardboard 300 are placed in the U-shaped storage groove 600, the posture of the fixture 100 can be adjusted so that the cutting device 40 is at its operation position. For example, as shown, the cutting device may travel horizontally. The tapered frontal end of the body 42 of the cutting device may guide the belt 308 for binding the bundled cardboard 300 into a spacing between the fixed cutter and the movable cutter. When the belt is at a proper position, the pneumatic actuator 70 actuates to rotate the movable cutter. The belt thus is cut off. When the belt supporting device is provided, due to the fact that the belt is also trapped in the groove and the clamping member, the belt that has been cut off from the bundled cardboard 300 would not fall off but is still captured by the clamping member. By moving the robotic arm, the belt that has been cut off from the bundled cardboard 300 can be moved to a proper position where the pneumatic actuator 70 is discharged to release the belt. In this way, the belt can be collected without messing up the working environment.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. A fixture for transferring a bundled cardboard, comprising:
a frame extending substantially in a first direction and comprising an upper side and a lower side;
a first gripper attached to the frame at a first place adjacent to the upper side and comprising a gripping plate extending in a second direction perpendicular to the first direction, the gripping plate comprising a gripping surface adapted to engage with a first surface of the bundled cardboard; and
a second gripper attached to the frame at a second place adjacent to the lower side and comprising at least one clamping arm, the clamping arm adapted to abut against a second surface of the bundled cardboard, the second surface being opposite to the first surface.

2. The fixture of claim 1, wherein the first gripper is movably attached to the frame such that the gripping plate is linearly movable along the first direction to change a distance between the gripping surface and the clamping arm.

3. The fixture of claim 2, further comprising a first pneumatic actuator fixedly attached to the frame and configured to move the first gripper along the first direction.

4. The fixture of claim 1, wherein the gripping surface is configured to engage with the first surface of the bundled cardboard via a vacuum suction.

5. The fixture of claim 4, wherein the gripping plate comprises M suction points distributed on the gripping surface and grouped into N groups, the suction points in each group being controlled by one air circulation circuit, M being an integer greater than 3, N being an integer between 1 and M.

6. The fixture of claim 1, wherein the second gripper is rotationally attached to the frame such that the clamping arm is rotatable around the first direction between an extended position at which the clamping arm protrudes from the frame and a retracted position at which the clamping arm does not enter a projection area of the gripping surface along the first direction.

7. The fixture of claim 6, wherein the second gripper comprises at least two clamping arms spaced from each other to abut against the second surface of the bundled cardboard at different positions, the at least two clamping arms being synchronously moved.

8. The fixture of claim 7, further comprising a second pneumatic actuator fixedly attached to the frame and a linkage mechanism configured to receive an output force from the second pneumatic actuator to synchronously drive the at least two clamping arms.

9. The fixture of claim 1, wherein the frame comprises an upper mount portion adapted to be attached to a robotic arm and a lower support portion adapted to abut against a side surface of the bundled cardboard.

10. The fixture of claim 1, further comprising a cutting device comprising:
a body fixedly attached to the frame;
a fixed cutter fixedly attached to the body; and
a movable cutter rotationally attached to the body, the movable cutter being rotatable between a cutting position at which the movable cutter contacts the fixed cutter to cut off a belt of the bundled cardboard and a separation position at which the movable cutter is separate from the fixed cutter.

11. The fixture of claim 10, wherein the cutting device comprises a third pneumatic actuator configured to drive the movable cutter, the movable cutter being shaped to rotate in response to a linear movement of the pneumatic actuator.

12. The fixture of claim 10, further comprising a belt supporting device configured to hold the belt that has been cut off from the bundled cardboard, comprising:
a groove arranged in the body; and
a clamping member fixed to the movable cutter, extending in parallel with the movable cutter and configured to engage with the groove when the movable cutter is at the cutting position.

13. A method for transferring a bundled cardboard, comprising:
picking up the bundled cardboard by acting on a first surface of the bundled cardboard by a first gripper;
rotating a second gripper to abut against a second surface of the bundled cardboard, the second surface being opposite to the second surface;
moving the first gripper toward the second gripper to reduce a distance between the first and second grippers; and
transferring the bundled cardboard.

14. The method of claim 13, wherein the picking up comprises vacuum sucking the first surface of the bundled cardboard by the first gripper.

15. A robot comprising a robotic arm; and
the fixture for transferring a bundled cardboard according to claim 1, the fixture being attached to the robotic arm.
